(19) United States
(12) Patent Application Publication
(10) Pub. No.: US 2026/0057726 A1
(43) Pub. Date: Feb. 26, 2026

(54) MONEY HANDLING DEVICE, MONEY HANDLING METHOD, AND MONEY HANDLING SYSTEM

(71) Applicant: GLORY LTD., Himeji-shi (JP)

(72) Inventor: Tsuyoshi Izumida, Hyogo (JP)

(21) Appl. No.: 19/308,360

(22) Filed: Aug. 25, 2025

(30) Foreign Application Priority Data
Aug. 26, 2024 (JP) 2024-144224

(51) Int. Cl. G07D 11/245; G07D 1/06; G07D 11/13; G07D 11/34

(52) U.S. Cl. CPC G07D 11/245; G07D 11/13; G07D 11/34; G07D 1/06; G07D 2201/00; G07D 2211/00

(57) ABSTRACT

A money handling device according to the present disclosure includes: a dispense operation unit configured to execute a dispense operation in response to an execution request for a process including the dispense operation received from another control device; a preparation operation unit configured to execute a preparation operation of preparing for the next dispense operation after the dispense operation unit has started execution of one dispense operation; and a completion notification unit configured to transmit to the another control device a completion notification indicating completion of execution of the one dispense operation at a time point in case that the one dispense operation and the preparation operation have been completed.

### CROSS REFERENCE TO RELATED APPLICATIONS

This application is entitled to and claims the benefit of Japanese Patent Application No. 2024-144224, filed on Aug. 26, 2024, the disclosure of which including the specification, drawings and abstract is incorporated herein by reference in its entirety.

### TECHNICAL FIELD

The present disclosure relates to a money handling device, a money handling method, and a money handling system for executing various processes related to money.

### BACKGROUND ART

Money handling devices that calculate the difference in amount between the deposited amount and the payment amount and automatically dispense change have become widespread. Such a money handling device is called an automatic change machine, for example.

### SUMMARY

A money handling device according to an aspect of the present disclosure comprises: a dispense operation unit configured to execute a dispense operation in response to an execution request for a process including the dispense operation received from another control device; a preparation operation unit configured to execute a preparation operation of preparing for the next dispense operation after the dispense operation unit has started execution of one dispense operation; and a completion notification unit configured to transmit to the another control device a completion notification indicating completion of execution of the one dispense operation in case that the one dispense operation and the preparation operation have been completed.

### BRIEF DESCRIPTION OF DRAWINGS

FIG. 1 is a diagram illustrating an example of a configuration of a money handling device;

FIG. 2 is a flowchart illustrating an example of an operation of the money handling device;

FIG. 3 is a diagram for describing a money handling system comprising a money handling device;

FIG. 4 is a schematic view illustrating a flow of money during a dispense operation;

FIG. 5 is a schematic view illustrating a flow of money during a preparation operation;

FIG. 6 is a schematic view illustrating a flow of money when a preparation operation is performed in parallel with a dispense operation;

FIG. 7 is a diagram for describing a money handling system comprising a money handling device;

FIG. 8 is a diagram for describing a relationship between the start timing of the dispense operation, and first to third examples of the start timing of the preparation operation; and

FIG. 9 is a diagram illustrating a hardware configuration for implementing various functional configurations of the money handling devices according to the embodiments.

### DESCRIPTION OF EMBODIMENTS

In retail stores such as supermarkets and convenience stores, when goods are purchased, at least two processes are performed: a goods registration process of registering goods (a process of registering goods identification information, price information, and the like), and a settlement process (a process such as accepting the deposit of the purchase amount and dispensing change) for the registered goods.

In retail stores, a device capable of performing both the goods registration process and the settlement process, such as the coin storing device, may be installed, or a device for the goods registration process and a device for the settlement process may be separately installed. A specific example of a device that performs the goods registration process is a POS (Point Of Sales) register. An example of a device that performs the settlement process is an automatic change machine.

Generally, an automatic change machine cannot start a next settlement process until the current settlement process is completed. Accordingly, when one settlement process is completed, the automatic change machine transmits a completion notification to the POS (Point Of Sales) register, and upon receiving the completion notification, the POS register requests the automatic change machine for the next settlement process.

Here, in a case where the automatic change machine is configured to execute a change replenishment operation (preparation operation) after the settlement process, and the POS register and the automatic change machine are separately installed, if the automatic change machine transmits the completion notification of the settlement process to the POS register at the time when the settlement process is completed, a situation may arise in which the POS register requests the next settlement process to the automatic change machine even though the change replenishment operation has not yet been completed. When such a situation occurs, the automatic change machine cannot start the next settlement process until the change replenishment operation is completed, thereby causing the purchaser of goods involved in the next settlement process to wait.

An object of the present disclosure is to provide a money handling device, a money handling method, and a money handling system for executing a dispense operation in response to a request from another control device in the money handling device, in which when the preparation operation of the dispense operation is completed, a completion notification of the dispense operation is transmitted to the control device.

A money handling device according to an aspect of the present disclosure comprises: a dispense operation unit configured to execute a dispense operation in response to an execution request for a process including the dispense operation received from another control device; a preparation operation unit configured to execute a preparation operation of preparing for the next dispense operation after the dispense operation unit has started execution of one dispense operation; and a completion notification unit configured to transmit to the another control device a completion notification indicating completion of execution of the one dispense operation in case that the one dispense operation and the preparation operation have been completed.

The money handling device according to an aspect of the present disclosure may further comprise: a first storage configured to store money used for the dispense operation; and a transport configured to transport the money one by one. The dispense operation unit may control the first storage and the transport to execute the dispense operation.

The money handling device according to an aspect of the present disclosure may further comprise a recognition unit configured to recognize the money transported by the transport. In the dispense operation, the dispense operation unit may cause the first storage to eject the money, and the transport to transport to an outlet an amount of the money of each denomination set based on the execution request in accordance with a recognition result of the recognition unit from among the money ejected from the first storage, the outlet being configured to dispense the money to outside.

In the money handling device according to an aspect of the present disclosure, the execution request may be a request that may cause the money handling device to execute the dispense operation, and comprises an amount of money of each denomination to be dispensed in the dispense operation, and in the dispense operation, the dispense operation unit may cause the transport to transport the amount of money of each denomination represented by the execution request.

In the money handling device according to an aspect of the present disclosure, the execution request may be a request configured to cause the money handling device to perform a settlement process comprising a deposit operation of receiving a deposit from outside, a calculation operation configured to calculate a difference between a deposited amount in the deposit operation and a settlement amount to be settled by the money handling device, and the dispense operation, the execution request comprising the settlement amount, and in the dispense operation, the dispense operation unit may cause the transport to transport an amount of the money of each denomination set based on the difference calculated by the calculation operation.

The money handling device according to an aspect of the present disclosure may further comprise a second storage configured to store the money. In the preparation operation, the preparation operation unit may cause the second storage to feed the money, and the transport to transport to the first storage the same amount of money as the money dispensed in the dispense operation for each denomination from among money fed from the second storage.

The money handling device according to an aspect of the present disclosure may further comprise a second storage configured to store money used for the preparation operation, in the preparation operation, the preparation operation unit may cause the second storage to feed the money, and the transport to transport to the first storage money from among money fed from the second storage until the amount of money of each denomination in the first storage becomes equal to or greater than standard amount set in advance.

In the money handling device according to an aspect of the present disclosure, the preparation operation unit may execute the preparation operation in parallel with the one dispense operation by the dispense operation unit.

In the money handling device according to an aspect of the present disclosure, the preparation operation unit may start the preparation operation after an elapse of a predetermined time after the money has been ejected from the first storage in the one dispense operation.

The money handling device according to an aspect of the present disclosure may further comprise a feeder configured to feed one by one to the transport the money ejected from the first storage. The preparation operation unit may start the preparation operation at a time point when a predetermined amount of money has been fed by the feeder.

The money handling device according to an aspect of the present disclosure may further comprise a feeder configured to feed the money ejected from the first storage one by one to the transport. The preparation operation unit may start the preparation operation at a time point when the same amount of money as the total amount of money to be dispensed in the one dispense operation have been fed by the feeder.

The money handling device according to an aspect of the present disclosure may further comprise a setting unit configured to set a time point when the preparation operation unit is caused to start execution of the preparation operation.

The money handling device according to an aspect of the present disclosure may further comprise an operation unit configured to receive an instruction related to the time point when the preparation operation is to be started. The setting unit may set the time point when the execution of the preparation operation is to be started based on the operation received.

In the money handling device according to an aspect of the present disclosure, when receiving the instruction of reducing the dispense time required for the dispense operation, the setting unit may set to start the preparation operation at the time point when the same amount of money as the total amount of money to be dispensed in the dispense operation is fed by the feeding unit.

The money handling device according to an aspect of the present disclosure may further comprise a monitoring unit configured to monitor the amount of money of each denomination stored in the second storage, in which the setting unit may be set to start the preparation operation after an elapse of a predetermined time after the money is ejected from the first storage in the dispense operation in the case where the ratio of the money stored in the second storage of each denomination is within a predetermined range.

In the money handling device according to an aspect of the present disclosure, in the case where the ratio of the money of each denomination stored in the second storage is not within the predetermined range, the setting unit may set to start the preparation operation at the time point when the same amount of money as the total amount of money to be dispensed in the dispense operation is fed by the feeding unit.

In the money handling device according to an aspect of the present disclosure, in the case where the ratio of the money stored in the second storage of each denomination is not within the first predetermined range, and the ratio is within a second predetermined range wider than the first predetermined range, the setting unit may set to start the preparation operation at the time point when the amount obtained by subtracting the amount of money fed by the feeding unit from the total amount of money to be dispensed in the dispense operation becomes a predetermined amount.

A money handling method according to an aspect of the present disclosure is for a money handling device, the method comprising: executing a dispense operation in response to an execution request for a process including the dispense operation received from another control device; executing a preparation operation of preparing for the next dispense operation after execution of one dispense operation is started; and transmitting to the another control device a completion notification indicating completion of execution of the one dispense operation in case that the one dispense operation and the preparation operation have been completed.

A money handling system according to an aspect of the present disclosure comprises: a control device configured to transmit to a money handling device a request of a process including a dispense operation; and a money handling device configured to execute the dispense operation in response to the execution request received from the control device, execute a preparation operation of preparing for the next dispense operation after execution of one dispense operation is started, and transmit to the control device a completion notification indicating completion of execution of the one dispense operation in case that the one dispense operation and the preparation operation have been completed.

According to the present disclosure, in a money handling device that executes a dispense operation in response to a request from another control device, a completion notification of the dispense operation is transmitted to the control device when the preparation operation of the dispense operation is completed, and thus the next dispense operation can be requested to the money handling device at the time point when the completion notification is received by the other control device.

Hereinafter, embodiments of the present disclosure will be described in detail with reference to the drawings. However, detailed descriptions of well-known matters and repeated descriptions of substantially identical configurations may be omitted. In addition, components common to each embodiment may be assigned the same reference numerals, and repeated descriptions thereof may be omitted.

### First Embodiment

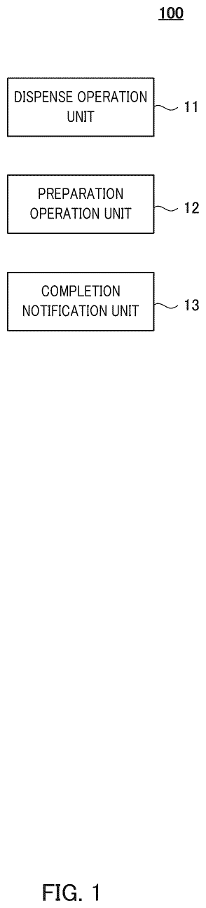

FIG. 1 is a diagram illustrating an example of a configuration of a money handling device according to the present disclosure. As illustrated in FIG. 1, a money handling device 100 according to the present disclosure comprises a dispense operation unit 11, a preparation operation unit 12, and a completion notification unit 13.

The dispense operation unit 11 executes a dispense operation in response to an execution request for a process including the dispense operation received from another control device. Another control device is a device external to the money handling device 100, and is a device that transmits an execution request to the money handling device 100. The dispense operation is an operation of outputting at least some of money stored in the money handling device 100 to the outside of the money handling device 100. The process including the dispense operation will be described later in the second embodiment.

The preparation operation unit 12 executes a preparation operation. The preparation operation is an operation of preparing for the next dispense operation by supplying money after money is dispensed by one dispense operation. The preparation operation unit 12 starts the preparation operation of preparing for the next dispense operation after one dispense operation has been started by the dispense operation unit 11.

Details of the dispense operation and preparation operation will be described later in the second embodiment. In addition, details of the timing when the preparation operation unit 12 starts the preparation operation will be described later in the third embodiment.

Upon completion of the preparation operation, the completion notification unit 13 transmits to the other control device a completion notification indicating completion of execution of one dispense operation. Specifically, the completion notification unit 13 transmits to the other control device a completion notification indicating completion of one dispense operation not at the completed timing of one dispense operation, but at the completed timing of the preparation operation.

The money handling device 100 cannot start the next dispense operation until completion of the preparation operation. As such, in the case where the completion timing of one dispense operation is earlier than the completion timing of the next preparation operation, if the money handling device 100 transmits the completion notification to the other control device at the completed timing of one dispense operation, and an execution request of the process including the next dispense operation is transmitted from the other control device in response to that completion notification, the money handling device 100 cannot respond to the execution request until completion of the preparation operation.

The completion notification unit 13 transmits to the other control device a completion notification indicating completion of one dispense operation not at the completed timing of one dispense operation, but at the completed timing of the preparation operation. In this manner, the other control device transmits an execution request of the process including the next dispense operation after the completion of the preparation operation, and thus the money handling device 100 can immediately respond to the execution request. In this manner, it is possible to prevent a situation where the money handling device 100 determines that the next dispense operation of another control device can be implemented even when the next dispense operation preparation has not been completed, and as a result the other control device requests the next dispense operation for the money handling device 100 such that it takes time until the money handling device 100 starts the next dispense operation.

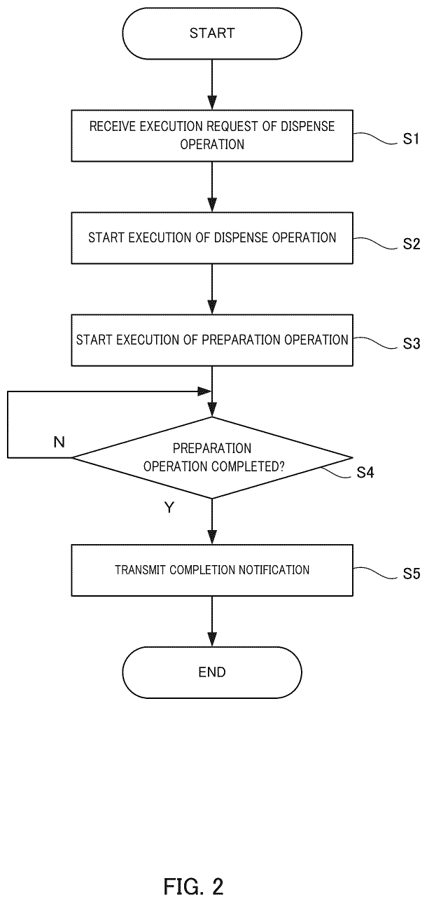

FIG. 2 is a flowchart illustrating an example of an operation of the money handling device 100.

At step S1, the money handling device 100 receives an execution request of the process including the dispense operation from another control device.

At step S2, the money handling device 100 starts one dispense operation.

At step S3, the money handling device 100 starts the preparation operation for the next dispense operation after the start of the execution of the one dispense operation at step S2.

At step S4, the money handling device 100 determines whether the preparation operation has been completed. When it is determined that the preparation operation has been completed (step S4: Y), the process proceeds to step S5, whereas when it is not determined that the preparation operation has been completed (step S4: N), the process of step S4 is repeated until completion of the preparation operation.

At step S5, the money handling device 100 transmits to the other control device a completion notification indicating completion of one dispense operation. In this manner, the other control device can determine that the money handling device 100 can start the next dispense operation.

### Second Embodiment

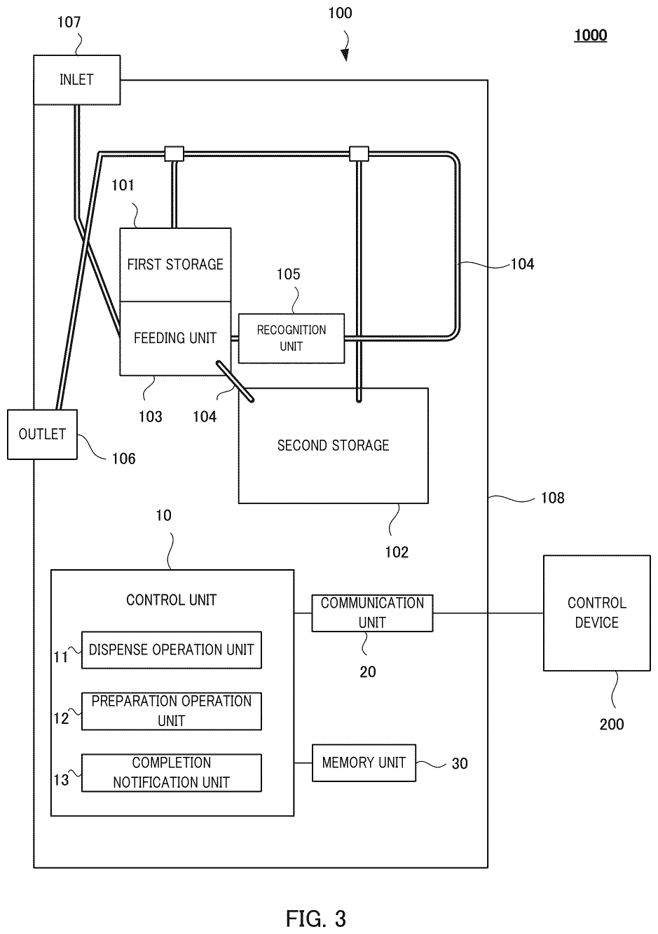

In a second embodiment, an operation of the money handling device including the dispense operation and the preparation operation is further elaborated. FIG. 3 is a diagram for describing a money handling system comprising a money handling device.

As illustrated in FIG. 3, a money handling system 1000 comprises the money handling device 100 and a control device 200. The control device 200 is a device external to the money handling device 100, and transmits to the money handling device 100 an execution request of the process including the dispense operation. The control device 200 is an example of another control device of the present disclosure.

Note that, in the present disclosure, the configuration in which the control device 200 is a device external to the money handling device 100 means that the control device 200 is operated by a processor different from the money handling device 100. The control device 200 and the money handling device 100 may be separate members disposed at positions adjacent to or separated from each other, or may be accommodated in one housing and appear externally as a single device comprising the control device 200 and the money handling device 100.

The money handling device 100 is an automatic change machine, for example.

The control device 200 is a POS (Point Of Sales) register, for example. The money handling device 100 serving as an automatic change machine and the control device 200 serving as a POS register are used to collect purchase prices of goods or services in retail stores or various service providing stores, for example.

The control device 200 performs a registration process of registering goods or services when collecting purchase prices of goods or services from customers at retail stores or various service providing stores. Then, the control device 200 transmits to the money handling device 100 an execution request of a settlement process to settle the purchase price revealed through the registration process. The money handling device 100 executes the settlement process in response to a reception of a request from the control device 200. The settlement process comprises at least a dispense operation of dispensing, as change, the difference between the deposited amount and the settlement amount (the purchase price of goods or services). Specifically, the settlement process is an example of the process including the dispense operation in the present disclosure. Note that, the settlement process may further comprise one or both a deposit operation of receiving a deposit from a customer, and a calculation operation of calculating the difference between the deposited amount and the settlement amount in the deposit operation.

The execution request transmitted from the control device 200 to the money handling device 100 may comprise a dispensing amount to be dispensed from the money handling device 100 as change. In this case, the control device 200 calculates the difference between the settlement amount and the deposited amount from the customer received at least at one of the money handling device 100 and a device (for example, a banknote handling device) other than the money handling device 100, and adds this difference in the execution request as a dispensing amount. The money handling device 100 determines the amount of the money of each denomination making up the dispensing amount through computation or the like, and executes a dispense operation to dispense the amount of money determined for each denomination.

In addition, the execution request transmitted from the control device 200 to the money handling device 100 may comprise the amount of money of each denomination to be dispensed by the money handling device 100 as change. In this case, the control device 200 calculates the difference between the purchase price and the deposited amount from the customer received at least at one of the money handling device 100 and a device (for example, a banknote handling device) other than the money handling device 100, determines the amount of money of each denomination corresponding to the difference, and adds the result in the execution request. The money handling device 100 executes a dispense operation in accordance with the amount of each denomination included in the execution request.

In addition, the money handling device 100 may calculate the change amount. In this case, it suffices that the execution request transmitted from the control device 200 to the money handling device 100 comprises the settlement amount representing the purchase price of goods or service. In this case, the money handling device 100 performs a deposit operation of receiving a deposit from the customer on the basis of the execution request. Alternatively, the money handling device 100 may acquire the deposited amount received by a deposit operation performed by a device other than the money handling device 100 (for example, a banknote handling device). Thereafter, the money handling device 100 performs a calculation operation of calculating the total amount of the deposited amount in the deposit operation and the deposited amount received by the banknote handling device, and calculating the difference between the total amount of the calculated deposited amount and the settlement amount, and performs a dispense operation of dispensing money on the basis of the calculated difference (specifically, change amount).

Next, a configuration of the money handling device 100 according to the second embodiment is described. As illustrated in FIG. 3, the money handling device 100 comprises a first storage 101, a second storage 102, a feeding unit 103, a transport unit 104, a recognition unit 105, an outlet 106, an inlet 107, and a case 108. In addition, as illustrated in FIG. 3, the money handling device 100 comprises a control unit 10, a communication unit 20, and a memory unit 30.

The first storage 101 stores money used for the dispense operation. The first storage 101 stores money of a plurality of denominations in a mixed manner. In addition, the first storage 101 can eject the stored money. The money is ejected from the first storage 101 to the feeding unit 103, for example.

The second storage 102 stores deposited money. The second storage 102 stores money of a plurality of denominations in a mixed manner. In addition, the second storage 102 can eject the stored money. The money is ejected from the second storage 102 to the feeding unit 103, for example.

The feeding unit 103 sequentially feeds put money one by one to the transport unit 104. The feeding unit 103 is provided near the second storage 102 on the lower side of the first storage 101, for example. In this manner, the money ejected from the first storage 101 is immediately put into the feeding unit 103, and thus the feeding from the first storage 101 to the transport unit 104 can be quickly performed.

The transport unit 104 transports money among the components of the money handling device 100. The transport unit 104 comprises at least a transport path for transporting money fed from the feeding unit 103 to the outlet 106, a transport path for transporting money fed from the feeding unit 103 to the first storage 101, a transport path for transporting money fed from the feeding unit 103 to the second storage 102, a transport path for transporting money fed from the second storage 102 to the feeding unit 103, and a transport path for transporting money deposited from the inlet 107 to the feeding unit 103. The transport unit 104 transports money by using a belt, for example.

The recognition unit 105 is a device that recognizes at least the denomination of money transported by the transport unit 104. The recognition unit 105 may also recognizes authentication, fitness and the like. In addition, the recognition unit 105 may have a function of counting the amount of money transported by the transport unit 104. The recognition unit 105 is composed of at least one sensor such as a magnetic sensor, an optical sensor such as an image sensor, and the like, for example.

The outlet 106 is an opening for ejecting money when dispensing money to the outside of the money handling device 100.

The inlet 107 is an opening for receiving a deposit from the outside of the money handling device 100.

The case 108 is a housing enclosing the above-described components of the money handling device 100.

The control unit 10 controls the operation of each unit of the money handling device 100. The control unit 10 is a processor such as a central processing unit (CPU) and the like, for example. As the functional configuration, the control unit 10 comprises the dispense operation unit 11, the preparation operation unit 12, and the completion notification unit 13 described in the first embodiment. The dispense operation unit 11 and the preparation operation unit 12 execute the dispense operation and preparation operation by controlling each unit of the above-described money handling device 100. The completion notification unit 13 controls the communication unit 20 to transmit a completion notification to the control device 200.

The communication unit 20 communicates with the control device 200 through wired communication or radio communication. The communication unit 20 receives an execution request from the control device 200. In addition, the communication unit 20 transmits a completion notification to the control device 200 under the control of the completion notification unit 13.

The memory unit 30 records a variety of information required for various operations of the money handling device 100, a program that is executed when the operation control of the control unit 10 is performed and the like. In particular, desirably, the memory unit 30 appropriately updates and records the amount of money of each denomination stored in the first storage 101 at that time point, and the amount of money of each denomination stored in the second storage 102 at that time point. The memory unit 30 is a non-volatile memory, for example.

### Money Stored in First Storage 101

Next, money stored in the first storage 101 are described. As described above, the first storage 101 stores money used in the dispense operation. The dispense operation in the money handling device 100 is an operation of dispensing change, and therefore the first storage 101 needs only to store the minimum required amount of money as change. In the following description, the money stored in the first storage 101 is referred to as change fund.

The upper limit of the amount of the money that may be dispensed as change depends on the currency. For example, in the case of yen, the upper limit of the amount of the money that may be dispensed as change is 999 yen. For example, in the case of euro, the upper limit of the amount of the money that may be dispensed as change is 4 euros and 99 cents.

The combination of minimum required denominations and the amount of money to be prepared as change fund is predetermined by the currency. In the case of yen, money that can correspond to all amounts up to 999 yen must be prepared as change fund. In the case of yen, the minimum required amount of each money is four 1-yen coins, one 5-yen coin, four 10-yen coins, one 50-yen coin, four 100-yen coins, and one 500-yen coin. In addition, in the case of US dollar, money that can correspond to all amounts up to 99 cents must be prepared as change fund. Since 50-cent coins and 1-dollar coins are rarely used, the minimum required amount of each money is four 1-cent coins, one 5-cent coin, two 10-cent coins, and three 25-cent coins. Further, in the case of euro, money that can correspond to all amounts up to 4 euros and 99 cents must be prepared as change fund. In the case of euro, the minimum required amount of each money is one 1-cent coin, two 2-cent coins, one 5-cent coin, one 10-cent coin, two 20-cent coins, one 50-cent coin, one 1-euro coin, and two 2-euro coins. In the present disclosure, the amount of money of each denomination that is the minimum necessary to handle all change with money is defined as the minimum configuration amount. The minimum configuration amount is an example of the standard amount of money in the present disclosure.

The second embodiment and the third embodiment, which will be described later, describe a case where money is stored in the first storage 101 in the minimum configuration amount. Note that, in the fourth embodiment, which will be described later, money is stored in the first storage 101 in an amount larger than the minimum configuration amount.

### Dispense Operation

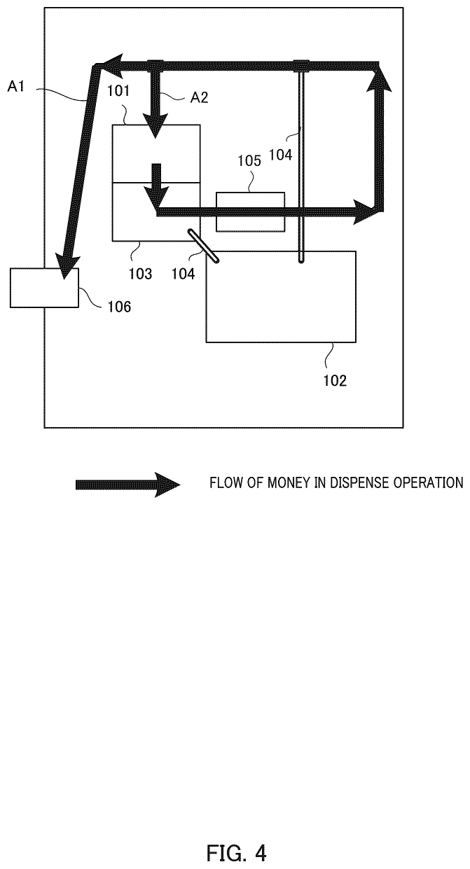

Next, the dispense operation in the money handling device 100 is described. FIG. 4 is a schematic view illustrating a flow of money during a dispense operation.

As described above, the dispense operation unit 11 of the money handling device 100 starts the dispense operation when an execution request of a settlement process including a dispense operation is received from the control device 200. Note that, the following description assumes that at the start of the dispense operation, the amount of money of each denomination to be dispensed has been determined. The amount of money of each denomination to be dispensed is information indicating which denominations of money, and how much money is to be dispensed.

First, the dispense operation unit 11 ejects, to the feeding unit 103, all of the change fund stored in the first storage 101 by controlling the first storage 101.

The feeding unit 103 comprises a disk having a protrusion on the surface, for example. The disk is tilted at a predetermined angle with respect to the vertical direction, and is rotated by a motor or the like while maintaining that tilted state. When money enters the feeding unit 103, most of the money is stored in the lower portion of the disk, and the money is caught by the protrusion and moved to the upper side one by one along with the rotation of the disk. The money caught by the protrusion and moved to the upper side is fed from a hole provided on the outer periphery side of the disk at the feeding unit 103. The hole is connected to the transport unit 104. With this configuration, the feeding unit 103 can feed the money one by one to the transport unit 104.

Note that, the configuration of the feeding unit 103 is not limited to the above-described configuration, as long as money acquired from the first storage 101 or the second storage 102 can be fed to the transport unit 104 one by one.

The money ejected to the feeding unit 103 is fed to the transport unit 104 one by one, and recognized by the recognition unit 105. When the fed money is money to be dispensed as a result of the recognition, the dispense operation unit 11 transports the money to the outlet 106 (see arrow A1 of FIG. 4). Note that, in the case where the fed money is money of a denomination instructed to be dispensed, whether the fed money is money to be dispensed is determined on the basis of whether a preliminarily set amount of money of the same denomination has already been transported to the outlet 106. When a preliminarily set amount of money of the same denomination as the fed money has not already been transported to the outlet 106, the fed money is transported to the outlet 106.

On the other hand, when the money of the same denomination as that of the fed money is not money of the denomination instructed to be dispensed, or is money of the denomination instructed to be dispensed and has already been transported to the outlet 106 in the preliminarily set amount as a result of the recognition, the fed money is not the money to be dispensed. When the fed money is not the money to be dispensed, the dispense operation unit 11 causes the transport unit 104 to transport the money to return to the first storage 101 (see arrow A2 of FIG. 4). The bottom portion of the first storage 101 that is opened at the start of the dispense operation is closed at the time when all of the money in the first storage 101 are ejected to the feeding unit 103, and through this operation, the money that is not to be dispensed can be returned to the first storage 101.

The dispense operation unit 11 repeats the above-described operation until all of the amount of money of each denomination to be dispensed are transported to the outlet 106. In this manner, the amount of money of each denomination to be dispensed can be dispensed from the change fund stored in the first storage 101.

### Preparation Operation

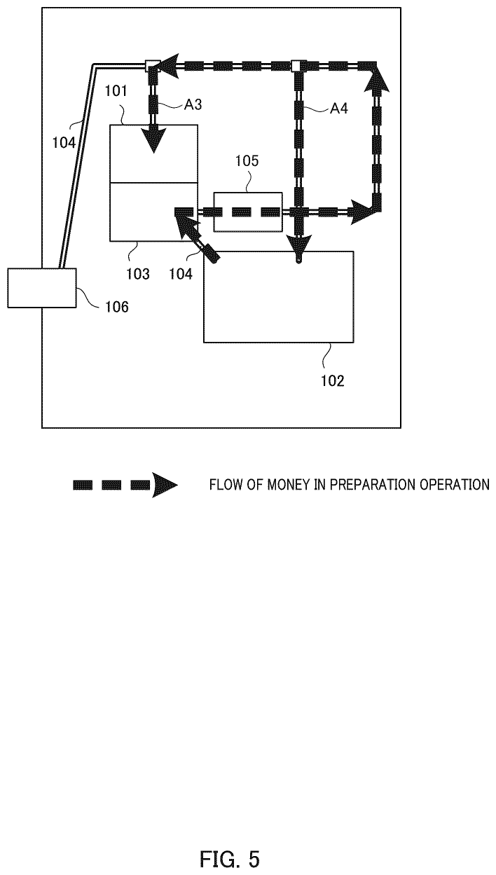

Next, a preparation operation in the money handling device 100 is described. The preparation operation is an operation of preparing for the next dispense operation by supplying money to the first storage 101 that no longer satisfy a predetermined storage amount, which is the minimum configuration amount in the present embodiment, due to one dispense operation. FIG. 5 is a schematic view illustrating a flow of money during a preparation operation.

First, the preparation operation unit 12 can randomly feed money from among the money stored in the second storage 102 by controlling the second storage 102. Here, the random feeding means that money can be fed without taking into account the denomination. Specifically, it is expected that the amount of money of each denomination included in money fed from the second storage 102 to the feeding unit 103 may differ for each feeding. The preparation operation unit 12 automatically executes the feeding of money from the second storage 102 to the feeding unit 103 at a predetermined interval until completion of the preparation operation, for example. The money fed from the second storage 102 are temporarily stored in the feeding unit 103.

The money fed from the feeding unit 103 are fed to the transport unit 104 one by one, and recognized by the recognition unit 105. When the fed money is money to be used for replenishment as a result of the recognition, the preparation operation unit 12 transports the money to the first storage 101 (see arrow A3 of FIG. 5). Note that, whether the fed money is money to be used for replenishment may be determined on the basis of whether the money of the same denomination as that of the fed money is stored in the first storage 101 in an amount of each denomination preliminarily set as the storage amount of money to be stored in the first storage 101, or in the present embodiment, the minimum configuration amount. In other words, whether the fed money is money to be used for replenishment may be determined on the basis of whether the money of the same denomination as that of the fed money has been dispensed in the dispense operation. When money of the same denomination as that of the money dispensed in the dispense operation has not been transported to the first storage 101 in the dispensed amount, the fed money is the money to be used for replenishment.

On the other hand, as a result the recognition, when money of the same denomination as that of the money dispensed in the dispense operation has already been transported to the first storage 101 in a predetermined storage amount, that is, the dispensed amount in the previous dispense operation, the fed money is not the money to be used for replenishment. When the fed money is not the money to be used for replenishment, the preparation operation unit 12 causes the transport unit 104 to transport the money to return to the second storage 102 (see arrow A4 of FIG. 5). Through this operation, the money not to be used for replenishment is returned to the second storage 102 from among the money fed from the second storage 102.

The preparation operation unit 12 repeats the above-described operation until the amount of money of each denomination to be used for replenishment are transported to the first storage 101. In this manner, the money inside the first storage 101 can be reset to the minimum configuration amount by using money for replenishment stored in the second storage 102.

### Dispense Operation and Preparation Operation Performed in Parallel

As described above, in the present disclosure, the preparation operation unit 12 of the money handling device 100 starts the preparation operation after one dispense operation has been started on the basis of an execution request of a settlement process including a dispense operation received from the control device 200. In this manner, in the present disclosure, in the period until one dispense operation is completed after the start of execution of the preparation operation, the preparation operation unit 12 can execute the preparation operation for the next dispense operation in parallel with the one dispense operation.

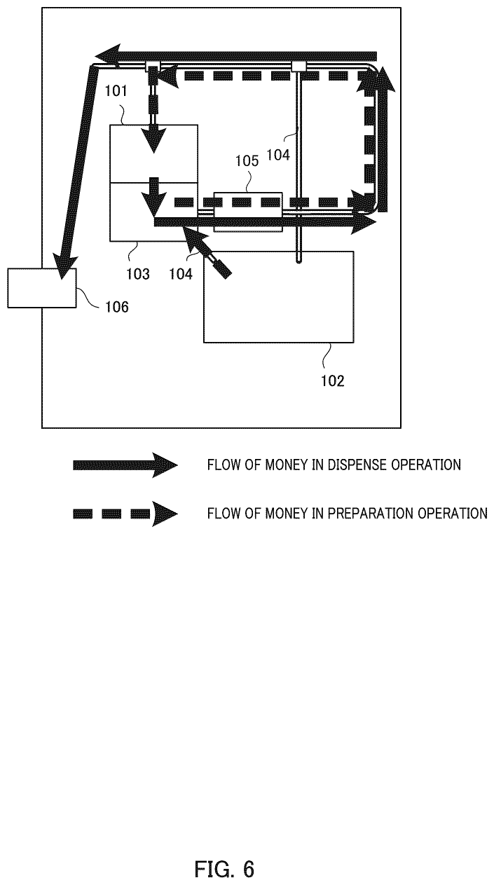

FIG. 6 is a schematic view illustrating a flow of money in the case where the preparation operation is performed in parallel with the dispense operation. In the following description, the operation in the case where the dispense operation and the preparation operation are performed in parallel with each other is referred to as parallel operation.

In the parallel operation, money ejected from the first storage 101 by the dispense operation that have not been fed, and money fed from the second storage 102 by the preparation operation are present in a mixed manner in the feeding unit 103.

Also in the parallel operation, a predetermined amount of money fed to the feeding unit 103 are fed to the transport unit 104 one by one, and recognized by the recognition unit 105. Then, when the fed money is money to be dispensed as a result of the recognition, the dispense operation unit 11 transports the money to the outlet 106. On the other hand, when the fed money is money to be used for replenishment as a result of the recognition, the preparation operation unit 12 transports the money to the first storage 101. Through this parallel operation, the dispense operation and the preparation operation can be simultaneously performed with no problem.

Note that, when the money fed from the feeding unit 103 is money to be dispensed as a result of the recognition, and is money to be used for replenishment, the dispense operation is preferentially executed. When the money fed from the feeding unit 103 is money to be dispensed and money to be used for replenishment, which operation, the money dispense operation and preparation operation, the money is to be preferentially used for may be preliminarily set by the administrator of the money handling device 100. For example, in the case where the administrator desires to reduce the dispense time, the administrator may set the operation such that money is preferentially used for the dispense operation. For example, in the case where the administrator desires to reduce the preparation time, the administrator may set the operation such that money is preferentially used for the preparation operation.

### Start Timing of Preparation Operation

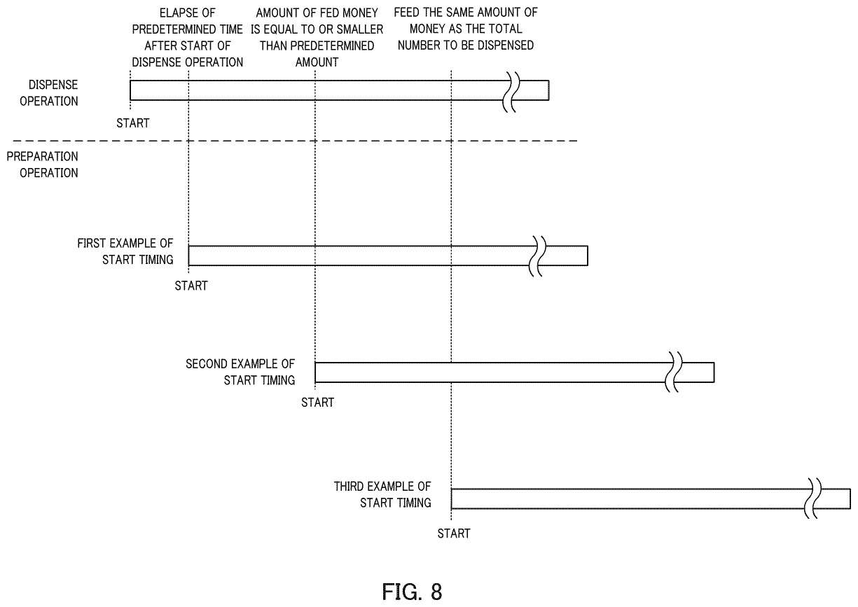

As described above, the preparation operation unit 12 starts the preparation operation after one dispense operation has been started. Here, the timing when the preparation operation unit 12 starts the preparation operation may be preliminarily set to any timing after the start of one dispense operation by the administrator of the money handling device 100 and the like, for example. Examples of the start timing of the preparation operation, and the difference between start timings are described below. FIG. 8 is a diagram for describing a relationship between the start timing of the dispense operation, and first to third examples of the start timing of the preparation operation. FIG. 8, in which the time advances toward the right side, conceptually illustrates temporal difference between the first to third examples of the start timing.

### First Example of Start Timing

In the first example of the start timing of the preparation operation, the preparation operation unit 12 starts the preparation operation after an elapse of a predetermined time after money is ejected from the first storage 101 in one dispense operation. The predetermined time may be preliminarily set by the administrator of the money handling device 100 and the like, for example.

In the first example of the start timing, the preparation operation is started regardless of the progress of one dispense operation. In this manner, by setting a relatively short predetermined time, the preparation operation for the next dispense operation can be started at a timing considerably earlier than the completion of one dispense operation. In this manner, in comparison with the case where the preparation operation for the next dispense operation is started after the completion of one dispense operation, it is possible to advance the timing when the preparation operation is completed and the next dispense operation can be started in the money handling device 100.

In the second example of the start timing, the preparation operation unit 12 starts the preparation operation at the time point when a predetermined amount of money has been fed by the feeding unit 103 in one dispense operation. The predetermined amount may be preliminarily set by the administrator of the money handling device 100 and the like, for example.

The total amount of money to be dispensed is the sum of the amount of money of each denomination that constitutes the money to be dispensed as described above. To give a specific example, when the change is 678 yen, the amount of money of each denomination to be dispensed is as follows.
500-yen coin: one
100-yen coin: one
50-yen coin: one
10-yen coin: two
5-yen coin: one
1-yen coin: three

In this case, the total amount of money to be dispensed is nine.

Here, it is assumed that the predetermined amount is six, for example. In this case, the preparation operation unit 12 starts the preparation operation when the amount of money fed by the feeding unit 103 reaches six, regardless of the denomination.

In this manner, in the second example of the start timing, the preparation operation is started at the time point when a predetermined amount of money has been fed by the feeding unit 103. In other words, in the second example of the start timing, the preparation operation is started when the progress of one dispense operation has advanced to a certain extent. The degree of the progress for starting the preparation operation may be adjusted depending on the predetermined amount set by the administrator of the money handling device 100.

Note that, since the total amount of money to be dispensed has been set at the start of one dispense operation, if the amount of money dispensed by the feeding unit 103 up to a certain time point is known, the amount of money remaining in the feeding unit 103 at that time point can also be determined. In this manner, in the second example of the start timing, instead of the time point when a predetermined amount of money has been fed by the feeding unit 103, it is possible to employ the time point when the amount of money remaining in the feeding unit 103 (hereinafter referred to as remaining amount) becomes a predetermined second amount. The predetermined second amount can be calculated by (total amount of money to be fed)-(predetermined amount). In this case, it suffices that the preparation operation is started at the time point when the amount of money remaining in the feeding unit 103 becomes the predetermined second amount.

In addition, in the second example of the start timing, instead of starting the preparation operation at the time point when the remaining amount becomes smaller than the predetermined second amount, the preparation operation unit 12 may start the preparation operation at the time point when the remaining amount becomes greater than a predetermined ratio of the total amount of money to be dispensed. In this case, the progress of one dispense operation can be more accurately reflected on the start timing of the preparation operation.

In the third example of the start timing, the preparation operation unit 12 starts the preparation operation at the time point when the total amount of money of each denomination to be dispensed has been fed from the feeding unit 103 in one dispense operation.

The time point when the total amount of money of each denomination to be dispensed has been fed from the feeding unit 103 is the time point when one dispense operation can be regarded as nearly completed, or in other words, the time point when almost all money to be dispensed has been fed from the feeding unit 103 and all that remains is to return to the first storage 101 the money of denominations not to be dispensed among the money fed from the first storage 101. In the third example of the start timing, the preparation operation unit 12 starts the preparation operation at that time point.

Hereinabove, the first to third examples of the start timing of the preparation operation have been described. In the first to third examples of the start timing, the preparation operation of the next dispense operation has been started before the completion of one dispense operation, and therefore the time from the start of the dispense operation to the completion of the preparation operation can be reduced in comparison with the case where the preparation operation is started after the completion of one dispense operation.

In the first example of the start timing, the preparation operation is started at a timing not taking into account the progress of one dispense operation as described above. In this manner, by setting a relatively short predetermined time, the preparation operation can also be started immediately after the start of one dispense operation, for example. In this case, it can be expected that the total time from the start of the dispense operation to the completion of the preparation operation is reduced.

It should be noted that, in the case where the preparation operation is executed in parallel with the dispense operation, the preparation operation periodically supplies the money to the feeding unit 103 (see FIG. 6), and as a result the total amount of money fed from the feeding unit 103 for the dispense operation is likely to increase. As such, as in the first example of the start timing, if the execution time of the preparation operation in parallel with the dispense operation is long, the time required for one dispense operation is likely to increase in comparison with the case where the preparation operation is started after the completion of one dispense operation. In view of this, the predetermined time may be adjusted so as to balance the effect of reducing the total time from the start of the dispense operation to the completion of the preparation operation achieved by the configuration in which the preparation operation is executed in parallel with the dispense operation, with the increase in the time required for dispense operation. For example, it is possible to experimentally set various predetermined times in the money handling device 100 actually installed in stores and the like, collect data related to the total time from the start of the dispense operation to the completion of the preparation operation and the increase in the time required for dispense operation, and determine the predetermined time such that the effect of shortening the total time from the start of the dispense operation to the completion of the preparation operation is maximized on the basis of the collected data. As described above, the determination of the predetermined time may be performed by the administrator of the money handling device 100, or may be performed by using statistical methods or prediction using machine learning on the basis of past data collected after experimentally setting various predetermined times.

In the third example of the start timing, the preparation operation is started at the timing when one dispense operation can be regarded as nearly completed. In this manner, unlike in the first example, the possibility of increase in the time required for dispense operation due to the preparation operation is executed in parallel with the dispense operation is low. However, in the third example, the preparation operation is started at a timing later than in the first example, and as a result the effect of reducing the total time from the start of the dispense operation to the completion of the preparation operation is likely to be weaker than in the first example.

In the second example of the start timing, the preparation operation begins at a point halfway between the first example and the third example. In this manner, when the predetermined amount of money serving as a threshold can be set to an appropriate value by prediction using statistical methods or machine learning, the effect of reducing the total time from the start of the dispense operation to the completion of the preparation operation can be expected as in the first example and third example.

In this manner, by appropriately setting the start timing of the preparation operation after the start of one dispense operation, the effect of reducing the total time from the start of the dispense operation to the completion of the preparation operation can be expected. Since the money handling device 100 transmits the completion notification to the control device 200 at the completed timing of the preparation operation, the total time from the start of the dispense operation to the completion of the preparation operation is reduced, and the period until the next customer settlement process is started after one customer settlement process can be reduced. Therefore, it can be expected to have the effect of comprehensively reducing the waiting time for customers using the money handling device 100.

### Third Embodiment

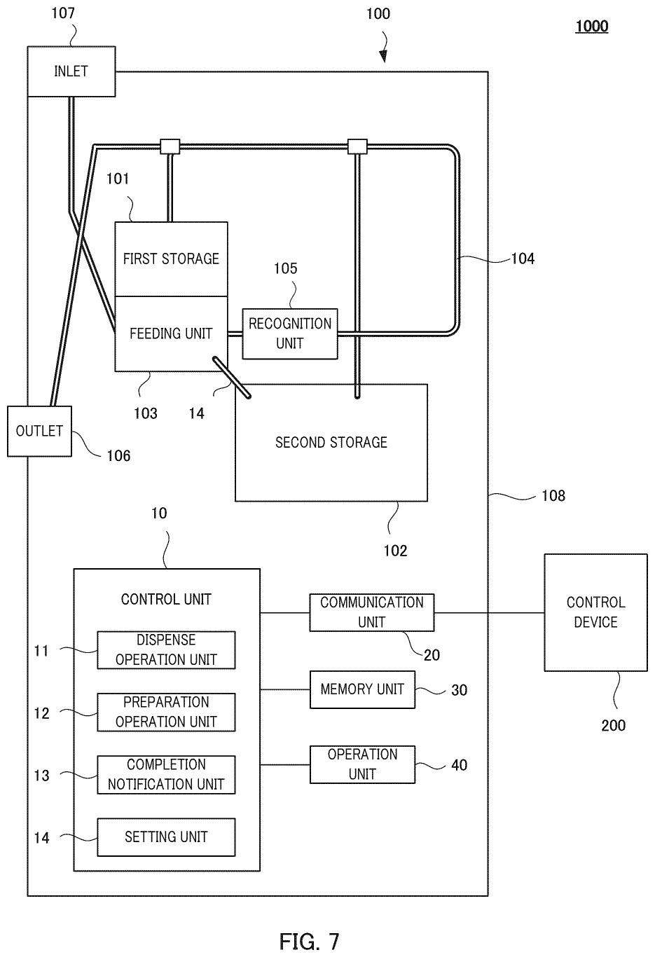

In a third embodiment, an aspect in which the start timing of the execution of the preparation operation can be arbitrarily set is elaborated. FIG. 7 is a diagram illustrating an example of a configuration of a money handling device according to the present disclosure.

As illustrated in FIG. 7, the money handling device 100 according to the third embodiment further comprises a setting unit 14 and an operation unit 40 in addition to the components of the money handling device illustrated in FIG. 3.

The setting unit 14 sets the time point when the preparation operation unit 12 is caused to execute the preparation operation. The setting unit 14 can appropriately select and set any start timing from among a plurality of preliminarily set start timings, for example. Examples of the plurality of preliminarily set start timings include the first to third examples described in the second embodiment. Alternatively, the setting unit 14 may be configured to be able to directly designate the time from the start of one dispense operation to the start of the next preparation operation of the dispense operation, for example.

The operation unit 40 is an operation device that receives the instruction related to the time point for starting the execution of the preparation operation. The operation unit 40 is composed of at least one device such as a button, a keyboard, a mouse, a trackball, and a touch pad.

The setting by the setting unit 14 may be performed on the basis of the operation performed through the operation unit 40 by the administrator of the money handling device 100, for example. In this case, the administrator can set the time point for starting the preparation operation while referring to the progress of the preparation operation and the dispense operation in the money handling device 100, for example.

In addition, the setting of the setting unit 14 may be performed with reference to the denomination configuration inside the second storage 102. As a specific example, in the case where the denomination configuration inside the second storage 102 is relatively balanced, the possibility of increase of the time required for dispense operation is low, and therefore the setting unit 14 sets the start timing to the first example of the start timing, which is likely to increase the time required for dispense operation. On the other hand, in the case where the denomination configuration inside the second storage 102 is not balanced, it is highly possible that the time required for dispense operation increases, and therefore the setting unit 14 sets the start timing to the start timing of the third example, which is unlikely to increase the time required for dispense operation. Note that, the state where the denomination configuration inside the second storage 102 is relatively balanced means that the amount of each denomination of the money inside the second storage 102 is relatively close to the multiple of the minimum configuration amount. On the other hand, the state where the denomination configuration inside the second storage 102 is not balanced means that the amount of each denomination of the money inside the second storage 102 deviates from the multiple of the minimum configuration amount.

In addition, the setting of the setting unit 14 may be performed by a trained model installed in the setting unit 14 on the basis of the learning result and the progress of the latest preparation operation and dispense operation in the money handling device 100. The trained model installed in the setting unit 14 is a model trained using, as training data, past data representing the total time from the start of one dispense operation to the completion of the preparation operation when the preparation operation is started at various start timings. In this manner, it is expected that the setting unit 14 can set the start timing that is significantly effective to reduce the total time from the start of the dispense operation to the completion of the preparation operation.

In this manner, by appropriately setting by the setting unit 14 the start timing of the preparation operation after the start of one dispense operation, the effect of reducing the total time from the start of the dispense operation to the completion of the preparation operation can be expected. Since the money handling device 100 transmits the completion notification to the control device 200 at the completed timing of the preparation operation, the total time from the start of the dispense operation to the completion of the preparation operation is reduced, and the period until the next customer settlement process is started after one customer settlement process can be reduced. Therefore, it can be expected to have the effect of comprehensively reducing the waiting time for customers using the money handling device 100.

### Fourth Embodiment

A fourth embodiment describes that a larger amount of money than the minimum configuration amount (the standard amount according to the present disclosure) are stored in the first storage. The configuration of the money handling device according to the fourth embodiment is the same as the configuration described in the second or third embodiment.

In the above-described second or third embodiment, it is assumed that the first storage 101 stores money in the minimum configuration amount. In the present fourth embodiment, an amount of money greater than the minimum configuration amount (surplus) is stored in advance in the first storage 101. Further, in the preparation operation, money of the same amount as the dispensed money is supplied to the first storage 101 for each denomination. In this manner, even when money equal to or less than the minimum configuration amount is dispensed through the dispense operation, an amount of money exceeding the minimum configuration amount remain in the first storage 101 due to the surplus. As a result, the time during which the dispensing operation cannot be handled can be minimized. In this manner, for example, even in the case where the settlement process including the dispense operation is continuously requested by the control device 200, continuous dispense operations can be handled without keeping the customer waiting.

Specific examples are described below. In the case of yen, the minimum configuration amount is four 1-yen coins, one 5-yen coin, four 10-yen coins, one 50-yen coin, four 100-yen coins, and one 500-yen coin. In the present fourth embodiment, the first storage 101 may store, for example, money in an amount more than twice the minimum configuration amount; in other words, the first storage 101 may store, in addition to money in the minimum configuration amount, further money in the minimum configuration amount as a surplus. That is, the first storage 101 may store in advance eight 1-yen coins, two 5-yen coins, eight 10-yen coins, two 50-yen coins, eight 100-yen coins, and two 500-yen coins.

Note that, in the fourth embodiment, a surplus of the amount of money is not limited. For example, money 0.5 times the minimum configuration amount may be stored in the first storage 101 as a surplus. In this case, the first storage 101 stores, as a whole, money 1.5 times the minimum configuration amount. A surplus of the amount of money may be preliminarily set, for example, by the administrator of the money handling device 100 and the like.

In the fourth embodiment, as in the second and third embodiments, the preparation operation unit 12, in the preparation operation, may supply to the first storage 101, for each denomination, the same amount of money as the amount dispensed in the dispense operation. In this manner, the amount of money including a surplus in the first storage 101 is maintained.

It should be noted that, for example, when a plurality of dispense operations are continuously performed, there may be situations where money replenishment to the first storage 101 by the preparation operation performed between dispense operations may not be performed in time. In this case, in the fourth embodiment, the preparation operation unit 12 may cause the next dispense operation by the dispense operation unit 11 to be started, for example, even in the case where the preparation operation is not completed, as long as money in the minimum configuration amount remain in the first storage 101, by regarding the preparation operation as completed. The preparation operation unit 12 may, for example, regard the preparation operation as completed if a request to execute the next dispense operation is received from the control device 200 during the preparation operation. Also in this case, since at least money in the minimum configuration amount remain in the first storage 101, at least the next dispense operation execution request can be handled without waiting time.

In this aspect, for example, even if the replenishment operation cannot be performed at all, it may become possible to handle a plurality of dispense operations continuously in some situations. Specific examples are described below. It is assumed that for the minimum configuration amount of U.S. dollars, which is four 1-cent coins, one 5-cent coin, two 10-cent coins, and three 25-cent coins, the first storage 101 stores seven 1-cent coins, two 5-cent coins, three 10-cent coins, and four 25-cent coins to include a surplus.

Here, if a dispense of 26 cents is requested in the first dispense operation, one 1-cent coin and one 25-cent coin are dispensed from the first storage 101, and the remaining amount of money in the first storage 101 becomes: six 1-cent coins, two 5-cent coins, three 10-cent coins, and three 25-cent coins, resulting in a state where money in the minimum configuration amount remain.

Next, if a dispense of 15 cents is requested in the second dispense operation without a preparation operation, one 5-cent coin and one 10-cent coin are dispensed from the first storage 101, and the remaining amount of money in the first storage 101 becomes: six 1-cent coins, one 5-cent coin, two 10-cent coins, and three 25-cent coins, resulting in a state where money in the minimum configuration amount remain.

Further, if a dispense of 2 cents is requested in the third dispense operation without a preparation operation, two 1-cent coins are dispensed from the first storage 101, and the remaining amount of money in the first storage 101 becomes: four 1-cent coins, one 5-cent coin, two 10-cent coins, and three 25-cent coins, resulting in a state where money in the minimum configuration amount still remain. In this case, it becomes possible to handle the next dispense operation as well without a preparation operation.

Alternatively, the preparation operation unit 12 may regard the preparation operation as completed when a predetermined maximum time has elapsed from the start of the preparation operation as long as money in the minimum configuration amount remain in the first storage 101 even if the preparation operation has not been completed.

In the fourth embodiment, in order to maintain, as much as possible, a state in which money in an amount including a surplus is stored in the first storage 101, the preparation operation may be started when the customer is not operating the money handling device 100. For example, the preparation operation unit 12 may automatically start the preparation operation when the customer has not visited a store or the like where the money handling device 100 and the control device 200 are installed for a while, and an execution request of a settlement process from the control device 200 has not been issued for a while. In this example, the preparation operation may also be automatically started at a timing when the money handling device 100 enters a power saving mode.

In addition, the preparation operation unit 12 may automatically start the preparation operation after maintenance of at least one of the money handling device 100 and the control device 200 has been performed. The maintenance includes, for example, collecting money from inside the money handling device 100 or supplying money to the money handling device 100 by the administrator of the money handling device 100 or a collection operator entrusted by the administrator.

In addition, the preparation operation unit 12 may automatically start the preparation operation when the control device 200 instructs another device (for example, a banknote handling device) to perform a settlement process using only banknotes, that is, when the money handling device 100 does not perform the settlement process.

Note that, in the case where the money handling device 100 can predict a customer's approach and operation by means of a sensor, a camera, or the like, the preparation operation may not be automatically started.

In addition, in the preparation operation performed between a plurality of dispense operations, money replenishment may not be performed until the money inside the first storage 101 reaches an amount including a surplus, and for example, replenishment may be performed only to the extent that a state in which money in the minimum configuration amount is stored can be maintained. Even with such an aspect, it is possible to handle operations without keeping the customer waiting, depending on the denomination of the money dispensed by the dispense operation.

Next, a method of setting the amount of surplus money will be described. As one example, the amount of surplus money may be set freely by the administrator of the money handling device 100 or the like. However, since the storage capacity of the first storage 101 has an upper limit, it is necessary to set the surplus in consideration of this upper limit.

As another example, the amount of surplus money may be set for each denomination. By setting a larger surplus in advance for denominations that are frequently dispensed, it is possible to suppress a shortage of coins of that denomination even if the situation in which the preparation operation cannot be completed continues.

As another example, the amount of surplus money may be set on the basis of the time zone or the denomination configuration inside the second storage 102. Further, by analyzing past log data, the amount of surplus money of each denomination may be set on the basis of customer turnover (such as the interval at which customers visit and the time taken to select goods). Alternatively, the amount of surplus money of each denomination may be set by analyzing the dispensing frequency for each denomination by analyzing past log data.

### Example of Hardware Configuration for Implementing Various Functional Configuration Of Money Handling Device 100

The following describes an example of a hardware configuration for implementing various functional configurations in the money handling device 100 according to the above-described embodiments. Note that, the various functional configurations of the money handling device 100 are mainly the dispense operation unit 11, the preparation operation unit 12, and the completion notification unit 13 illustrated in FIGS. 1 and 3.

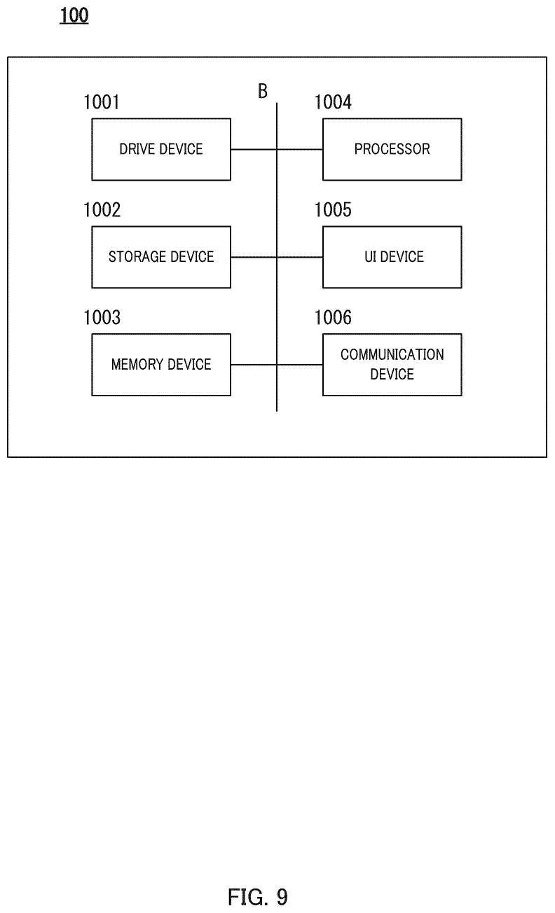

In the disclosure, the circuitry, units, or means are hardware that carry out or are programmed to perform the recited functionality. FIG. 9 illustrates an example of a hardware configuration for implementing various functional configurations of the money handling device 100. As an example, the money handling device 100 is a computer comprising a drive device 1001, a storage device 1002, a memory device 1003, a processor 1004, a user interface (UI) device 1005 and a communication device 1006, which are mutually connected via a bus B.

When a program or instruction for realizing various functions and processes in the money handling device 100 is stored in a removable storage medium such as a compact Disc-Read Only Memory (CD-ROM) or flash memory, the storage medium is set in the drive device 1001. Accordingly, the program or instruction is installed from the storage medium to the storage device 1002 or the memory device 1003 via the drive device 1001. However, the program or instruction does not necessarily have to be installed from the storage medium and may be downloaded from an external device via a network.

The storage device 1002 is implemented by a hard disk drive or the like. The storage device 1002 stores, together with the installed program or instruction, files and data used for the execution of the program or instruction.

The memory device 1003 is implemented by a random access memory, static memory, or the like, and upon activation of the program or instruction, reads and stores the program or instruction and data from the storage device 1002. The storage device 1002, the memory device 1003, and the removable storage medium may collectively be referred to as a non-transitory tangible storage medium.

The processor 1004 may be implemented by one or more central processing units (CPUs), graphics processing units (GPUs), or processing circuitry comprising one or more processor cores, and executes various functions and processes of the money handling device 100 in accordance with a program, instruction, or data such as parameters necessary for executing the program or instruction, stored in the memory device 1003.

The UI device 1005 may be composed of input devices such as a keyboard, mouse, camera, and microphone; output devices such as a display, speaker, headset, and printer; and input/output devices such as a touch panel, and implements an interface between the user of the money handling device 100 and the money handling device 100. For example, the user operates the money handling device 100 by manipulating a graphical user interface (GUI) displayed on the display or touch panel using the keyboard, mouse, or the like.

The communication device 1006 is implemented by various communication circuits that perform wired and/or wireless communication processing with external devices, the Internet, a local area network (LAN), a cellular network, or other communication networks.

The above-described hardware configuration is merely an example, and the money handling device of the present disclosure may be implemented by any other suitable hardware configuration.

What is claimed is:

1. A money handling device comprising:
a dispense operation unit configured to execute a dispense operation in response to an execution request for a process including the dispense operation received from another control device;
a preparation operation unit configured to execute a preparation operation of preparing for the next dispense operation after the dispense operation unit has started execution of one dispense operation; and
a completion notification unit configured to transmit to the another control device a completion notification indicating completion of execution of the one dispense operation in case that the one dispense operation and the preparation operation have been completed.

2. The money handling device according to claim 1, further comprising:
a first storage configured to store money used for the dispense operation; and
a transport configured to transport the money one by one,
wherein the dispense operation unit controls the first storage and the transport to execute the dispense operation.

3. The money handling device according to claim 2, further comprising a recognition unit configured to recognize the money transported by the transport,
wherein in the dispense operation, the dispense operation unit causes:
the first storage to eject the money; and
the transport to transport to an outlet an amount of the money of each denomination set based on the execution request in accordance with a recognition result of the recognition unit from among the money ejected from the first storage, the outlet being configured to dispense the money to outside.

4. The money handling device according to claim 3,
wherein the execution request is a request that causes the money handling device to execute the dispense operation, and comprises an amount of money of each denomination to be dispensed in the dispense operation, and
wherein in the dispense operation, the dispense operation unit causes the transport to transport the amount of money of each denomination represented by the execution request.

5. The money handling device according to claim 3,
wherein the execution request is a request configured to cause the money handling device to perform a settlement process comprising a deposit operation of receiving a deposit from outside, a calculation operation configured to calculate a difference between a deposited amount in the deposit operation and a settlement amount to be settled by the money handling device, and the dispense operation, the execution request comprising the settlement amount, and
wherein in the dispense operation, the dispense operation unit causes the transport to transport an amount of the money of each denomination set based on the difference calculated by the calculation operation.

6. The money handling device according to claim 3, further comprising a second storage configured to store the money,
wherein in the preparation operation, the preparation operation unit causes:
the second storage to feed the money; and
the transport to transport to the first storage the same amount of money as the money dispensed in the dispense operation for each denomination from among money fed from the second storage.

7. The money handling device according to claim 3, further comprising a second storage configured to store money used for the preparation operation,
wherein in the preparation operation, the preparation operation unit causes:
the second storage to feed the money; and
the transport to transport to the first storage money from among money fed from the second storage until the amount of money of each denomination in the first storage becomes equal to or greater than standard amount set in advance.

8. The money handling device according to claim 6, wherein the preparation operation unit executes the preparation operation in parallel with the one dispense operation by the dispense operation unit.

9. The money handling device according to claim 8, wherein the preparation operation unit starts the preparation operation after an elapse of a predetermined time after the money has been ejected from the first storage in the one dispense operation.

10. The money handling device according to claim 8, further comprising a feeder configured to feed the money ejected from the first storage one by one to the transport,
wherein the preparation operation unit starts the preparation operation when a predetermined amount of money has been fed by the feeder.

11. The money handling device according to claim 8, further comprising a feeder configured to feed the money ejected from the first storage one by one to the transport,
wherein the preparation operation unit starts the preparation operation when the money to be dispensed in the one dispense operation has been fed by the feeder.

12. The money handling device according to claim 8, further comprising a setting unit configured to set a time point when the preparation operation unit is caused to start execution of the preparation operation.

13. The money handling device according to claim 12, further comprising an operation unit configured to receive an operation related to the time point when the preparation operation is to be started,
wherein the setting unit sets the time point when the execution of the preparation operation is to be started based on the operation received.

14. A money handling method for a money handling device, the method comprising:
executing a dispense operation in response to an execution request for a process including the dispense operation received from another control device;
executing a preparation operation of preparing for the next dispense operation after execution of one dispense operation is started; and
transmitting to the another control device a completion notification indicating completion of execution of the one dispense operation in case that the one dispense operation and the preparation operation have been completed.

15. A money handling system comprising:
a control device configured to transmit to a money handling device an execution request of a process including a dispense operation; and
a money handling device configured to execute the dispense operation in response to the execution request received from the control device, execute a preparation operation of preparing for the next dispense operation after execution of one dispense operation is started, and transmit to the control device a completion notification indicating completion of execution of the one dispense operation in case that the one dispense operation and the preparation operation have been completed.
